(19) United States
(12) Patent Application Publication
(10) Pub. No.: US 2006/0064868 A1
(43) Pub. Date: Mar. 30, 2006

(54) Method for producing a lithium polymeric battery cell

(76) Inventor: YU-Ta Tu, Hsinchu Hsien (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/202,694

(22) Filed: Aug. 11, 2005

(30) Foreign Application Priority Data
Sep. 24, 2004 (TW) 93129057

(51) Int. Cl. H01M 6/00

(52) U.S. Cl. 29/623.5

(57) ABSTRACT

The present invention provides a method for producing a lithium polymeric battery cell. The method comprises the steps of forming a cathode comprising a first polymeric plasticizer, forming an anode comprising a second polymeric plasticizer, forming a separator comprising a third polymeric plasticizer, forming a bicell by combining the cathode, the anode and the separator, removing the first, second and third polymeric plasticizers, and inserting an electrolyte solution into the bicell.

### BACKGROUND OF INVENTION

A. Technical Field of the Invention

This invention relates to a method for producing a lithium polymeric battery cell. More particularly, the invention further relates to a method for producing a lithium polymeric battery cell by a polymeric plasticizer.

B. Description of the Prior Art

Recently, as various portable electronic devices develop rapidly, the secondary batteries with lighter weight, higher performance and lower costs in large quantities are eagerly needed. Among all secondary batteries, lithium polymeric batteries meet the above requirements most. They have high energy densities, long cycle times, high operation voltages, long lifetimes, and high security.

Since Bellcore disclosed Plastic Lithium Ion battery in the 90s, it has been popular to research lithium polymeric battery cells. In U.S. Pat. No. 5,296,318, Bellcore uses dibutyl phthalate (DBP) as a plasticizer in order for anode and cathode pastes to form films and separate from substrates. Then an anode plate, a separator, and a cathode plate are combined into a bicell. After that, DBP was extracted by methanol solvent so as to make them porous. Finally, the bicell was dried in the vacuum and inserted with a liquid electrolyte solution.

In the above process, however, it requires a large amount of methanol solvent to completely extract DBP and DBP dissolved in the methanol is hard to recycle. Thus it increases the production cost. Moreover, DBP is a regulatory toxic material, so that the government strictly regulates the way of its manufacturing, selling, using, storing and disposing. Thus, a battery manufactured by DBP is neither cost competitive nor environment protective. Furthermore, because decomposition voltage of DBP is low, the battery cell with the DBP remains would result in charging and discharging for longer time, i.e. poor efficiency. Therefore, how to solve the above problems is an urgent task in the current development of lithium polymeric battery cell.

### SUMMARY OF THE INVENTION

An objective of this invention is to provide a method for producing a lithium polymeric battery cell to solve the problems of higher cost and poorer property resulted from DBP plasticizer.

Another objective of this invention is to provide a method for producing a lithium polymeric battery cell that protects environment.

Another objective of this invention is to provide a method for producing a lithium polymeric battery cell that is easy to process and that can increase process yield.

The present invention provides a method for producing a lithium polymeric battery cell. The method comprises the steps of forming a cathode comprising a first polymeric plasticizer, forming an anode comprising a second polymeric plasticizer, forming a separator comprising a third polymeric plasticizer, forming a bicell by combining the cathode, the anode and the separator, removing the first, second and third polymeric plasticizers, and inserting an electrolyte solution into the bicell, wherein the first, second and third polymeric plasticizers are chosen from the group consisting of polyester and bisphenol alkoxylate.

According to the invention, even when the polymeric plasticizers are incompletely extracted in subsequent process and remain in the cell, the lithium polymeric battery cell still meets the requirement of environmental protection.

The remaining polymeric plasticizers would not negatively impact on the properties of the battery cell. The produced lithium polymeric battery cell is more durable to voltage.

According to the invention, the polymeric plasticizers are lower in cost and easy to get so that the produced lithium polymeric battery cell is lower in cost.

### BRIEF DESCRIPTION OF THE DRAWINGS

FIG. 1 shows a flowchart according to the method for producing a lithium polymeric battery cell in the invention.

### DETAILED DESCRIPTION OF THE PRESENT INVENTION

The present inventor finds that polymeric plasticizers can be used to produce the cathode, the anode and the separator of a lithium polymeric battery cell to achieve the concept of this invention.

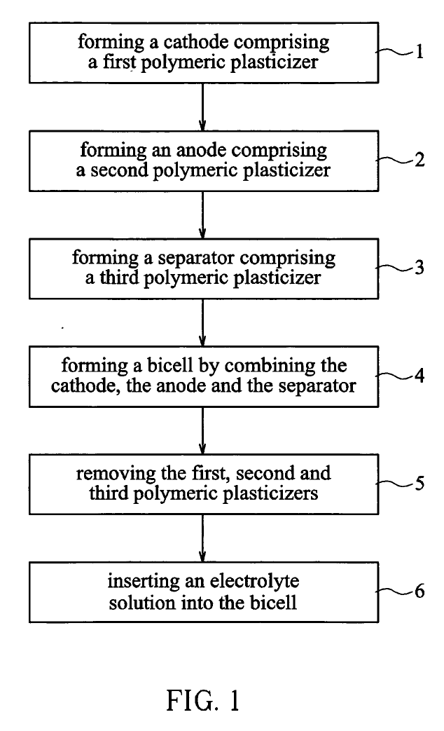

The present invention will be described in detail with reference to FIG. 1. FIG. 1 shows a flowchart according to the method for producing a lithium polymeric battery cell in the invention, which is similar to conventional method except that polymeric plasticizers rather than DBP are used. The polymeric plasticizers of the invention are polyester, bisphenol alkoxylate, and the like.

In step 1 shown in FIG. 1, a cathode comprising a first polymeric plasticizer is formed by mixing a binder, a conduction auxiliary, an active material and a polymeric plasticizer, wherein the content of the polymeric plasticizer in the cathode is from 8 wt % to 25 wt %, more preferably from 13 wt % to 20 wt %, the content of the binder such as polyvinylidene fluoride is from 7 wt % to 10 wt %, the content of the conduction auxiliary such as conductive carbon black is from 3 wt % to 6 wt %, and the content of the active material such as lithium compound is from 65 wt % to 75 wt %. The reason of the upper limit of the polymeric plasticizer resides in that, if the content of polymeric plasticizer is too high, the electrode plate will be too soft to be processed in the subsequent process. The reason of the lower limit resides in that, if the content of polymeric plasticizer is too low, the electrode plate will be too rigid to be processed in the subsequent process. Moreover, the deficient polymeric plasticizer would also result in too few pores formed after the subsequent extraction process, thus making celluar properties poor.

Then, a solvent such as acetone is added to the mixture so as to make cathode paste. The cathode paste is uniformly coated on a substrate, then dried, and cut into a desired size. The preparation of the cathode is finished.

In step 2 shown in FIG. 1, an anode comprising a second polymeric plasticizer is formed by the same procedure with the cathode preparation. Hence, the process of the anode preparation is not explained in detail. The content of the polymeric plasticizer in the anode is from 11 wt % to 27 wt %, more preferably from 16 wt % to 22 wt %, the content of the binder such as polyvinylidene fluoride is from 7 wt % to 10 wt %, the content of the conduction auxiliary such as conductive carbon black is from 2 wt % to 4 wt %, and the content of the active material such as mesophase carbon micro beads is from 67 wt % to 71 wt %.

In step 3, a separator comprising a third polymeric plasticizer is formed by the same procedure with the cathode preparation except mixing a binder, a polymeric plasticizer, and silicon dioxide to make paste. The content of the polymeric plasticizer in the separator is from 40 wt % to 60 wt %, more preferably from 45 wt % to 55 wt %, the content of the binder such as polyvinylidene fluoride is from 25 wt % to 33 wt %, the content of the silicon dioxide is from 15 wt % to 22 wt %.

Then, in step 4, a bicell is formed by combining the cathode, the anode and the separator. In step 5, the first, second and third polymeric plasticizers are removed by the method such as methanol extraction. Finally, an electrolyte solution is inserted into the bicell to activate the bicell by charging and discharging. Thus, a lithium polymeric battery cell is produced.

The invention has been explained above. The above method and properties of battery cell produced by the method will be further described with reference to the following two embodiments. Note that the embodiments are only illustrative, not restrictive.

### EMBODIMENT 1

### Using Bisphenol Alkoxylate as Polymeric Plasticizers

The cathode of the lithium polymeric battery cell is composed of an active material, a conduction auxiliary, a binder, and a polymeric plasticizer (75:5:7:13) by weight. The active material is the mixture of LiCoO₂ (LectroPlus 700 manufactured by FMC Corporation) and LiNi_{0.94}Co_{0.06}O₂ (1:1) by weight. The conduction auxiliary is conductive carbon black (Super-P manufactured by TIMCAL Graphite & Carbon). The binder is polyvinylidene fluoride (PVDF) (Kynar 2801 manufactured by ATOFINA Chemicals). The polymeric plasticizer is bisphenol alkoxylate (NAC TIC MONATRA 3060 manufactured by GRAN HARM). Acetone is added as a solvent to make cathode paste. Then the cathode paste is coated with blade to 180 g/m² basis weight to form cathode film. The cathode film is grinded with a cathode collector such as an aluminum net to form a cathode plate.

The anode of the lithium polymeric battery cell is composed of an active material, a conduction auxiliary, a binder, and a polymeric plasticizer (69:3:9:19) by weight. The active material is mesophase carbon micro bead (MCMB) (CMS manufactured by Shanghai Shanshan Tech). The conduction auxiliary is conductive carbon black (Super-P manufactured by TIMCAL Graphite & Carbon). The binder is polyvinylidene fluoride (PVDF) (Kynar 2801 manufactured by ATOFINA Chemicals). The polymeric plasticizer is bisphenol alkoxylate (NAC TIC MONATRA 3060 manufactured by GRAN HARM). Acetone is added as a solvent to make anode paste. Then the paste is coated with blade to 180 g/m² basis weight to form a film. The film is grinded with an anode collector such as a copper net to form an anode plate.

The separator is composed of a binder, a polymeric plasticizer and silicon dioxide (25:55:20) by weight. The binder is polyvinylidene fluoride (PVDF) (Kynar 2801 manufactured by ATOFINA Chemicals). The polymeric plasticizer is bisphenol alkoxylate (NAC TIC MONATRA 3060 manufactured by GRAN HARM). The silicon dioxide is VPAEROPERL 300 pharma manufactured by Degussa. Acetone is added as a solvent to make separator paste. Then the paste is coated with blade to 50 μm to form a separator.

The cathode and anode plates and separator are cut into the 633048 size and combined into a bicell. The polymeric plasticizers are removed by methanol extraction. The bicell is then baked, soldered with conductive tabs, sealed in an aluminum foil bag, dried in the vacuum at 85° C. for twelve hours, and inserted with an electrolyte solution. The electrolyte solution is prepared by dissolving 1M LiPF₆ into the solution composed of ethylene carbonate (EC), dimethyl carbonate (DMC), diethyl carbonate (DEC) and vinylene carbonate (VC) (49:39.2:9.8:2) by volume. The bicell is still placed for eight hours to activate by charging and discharging.

### EMBODIMENT 2

### Using Polyester as Polymeric Plasticizers

The cathode of the lithium polymeric battery cell in this embodiment is composed of an active material, a conduction auxiliary, a binder, and a polymeric plasticizer (73:4:7:16) by weight. The active material is LiCoO₂ (LectroPlus 700 manufactured by FMC Corporation). The conduction auxiliary is conductive carbon black (Super-P manufactured by TIMCAL Graphite & Carbon). The binder is polyvinylidene fluoride (PVDF) (Kynar 2801 manufactured by ATOFINA Chemicals). The polymeric plasticizer is polyester (UNIQEMA priplast 3159). Acetone is added as a solvent to make cathode paste. Then the cathode paste is coated with blade to 180 g/m² basis weight to form a cathode film. The cathode film is grinded with a cathode collector such as aluminum net to form a cathode plate.

The anode of the lithium polymeric battery cell is composed of an active material, a conduction auxiliary, a binder, and a polymeric plasticizer (67:2:9:22) by weight. The active material is mesophase carbon micro bead (MCMB) (CMS manufactured by Shanghai Shanshan Tech). The conduction auxiliary is conductive carbon black (Super-P manufactured by TIMCAL Graphite & Carbon). The binder is polyvinylidene fluoride (PVDF) (Kynar 2801 manufactured by ATOFINA Chemicals). The polymeric plasticizer is polyester (UNIQEMA priplast 3159). Acetone is added as a solvent to make anode paste. Then the paste is coated with blade to 180 g/m² basis weight to form a film. The film is grinded with an anode collector such as a copper net to form an anode plate.

The separator is composed of a binder, a polymeric plasticizer and silicon dioxide (30:55:15) by weight. The binder is polyvinylidene fluoride (PVDF) (Kynar 2801 manufactured by ATOFINA Chemicals). The polymeric plasticizer is polyester (UNIQEMA priplast 3159). The silicon dioxide is VPAEROPERL 300 pharma manufactured by Degussa. Acetone is added as a solvent to make separator paste. Then the paste is coated with blade to 50 μm to form a separator.

The cathode and anode plates and separator are cut into the 633048 size and combined into a bicell. The polymeric plasticizers are removed by methanol extraction. The bicell is then baked, soldered with conductive tabs, sealed in an aluminum foil bag, dried in the vacuum at 85° C. for twelve hours, and inserted with an electrolyte solution. The electrolyte solution is prepared by dissolving 1M LiPF₆ into the solution composed of ethylene carbonate (EC), dimethyl carbonate (DMC) and propylene carbonate (PC) (4:5:1) by volume. The bicell is still placed for eight hours to activate by charging and discharging.

The lithium polymeric battery cells of Embodiment 1 and Embodiment 2 are tested. Their properties are shown in Table 1 and Table 2 and compared with conventional properties of battery cells produced by DBP plasticizer respectively.

TABLE 1

| | The cell of | The cell produced |
|---|---|---|
| Item | Embodiment 1 | by DBP plasticizer |
| 0.5C | 98˜99 | 96˜97 |
| charge/discharge | | |
| efficiency(%) | | |
| internal resistance | 60˜65 | 70˜75 |
| (mΩ) | | |
| cycle life (0.5C | 95.2 | 90.5 |
| charge/discharge | | |
| 100 times)(%) | | |
| self-discharge (28 | 92.4 | 88.1 |
| days)(%) | | |
| separator pull | 4.552 | 3.871 |
| strength (N/mm²) | | |
| electrode plate pull | 1.129 | 0.941 |
| strength (N/mm²) | | |

TABLE 2

| | The cell of | The cell produced |
|---|---|---|
| Item | Embodiment 2 | by DBP plasticizer |
| 0.5C | 98.5˜99.6 | 96.3˜97.2 |
| charge/discharge | | |
| efficiency (%) | | |
| internal resistance | 61˜67 | 69˜74 |
| (mΩ) | | |
| cycle life (0.5C | 94.8 | 91 |
| charge/discharge | | |
| 100 times)(%) | | |
| self-discharge (28 | 91.5 | 89.2 |
| days)(%) | | |
| separator pull | 4.234 | 3.562 |
| strength (N/mm²) | | |
| electrode plate pull | 1.078 | 0.905 |
| strength (N/mm²) | | |

As shown in Table 1 and 2, the lithium polymeric battery cells in this invention are 5 obviously superior to the cells produced by DBP plasticizer in the electrical properties such as 0.5C charge/discharge efficiency, internal resistance, cycle life, and self-discharge in 28 days and in process properties such as separator pull strength and electrode plate pull strength.

Therefore, this invention obtains lithium polymeric battery cells with better electrical properties, easier process, lower cost, and environmental protection.

The invention has been illustrated with exemplification. It should be understood that the above illustration are only descriptive but not restrictive. Those skilled in the art can finish any kind of alternation or modification according to the invention. Thus, the following claims are intended to encompass all kinds of alternation or modification of the invention.

What is claimed is:

1. A method for producing a lithium polymeric battery cell comprising:
forming a cathode comprising a first polymeric plasticizer;
forming an anode comprising a second polymeric plasticizer;
forming a separator comprising a third polymeric plasticizer;
forming a bicell by combining the cathode, the anode and the separator;
removing the first, second and third polymeric plasticizers; and
inserting an electrolyte solution into the bicell.

2. The method of claim 1, wherein the first, second and third polymeric plasticizers are chosen from the group consisting of polyester and bisphenol alkoxylate.

3. The method of claim 1, wherein the content of the first polymeric plasticizer in the cathode is from 8 wt % to 25 wt %.

4. The method of claim 1, wherein the content of the first polymeric plasticizer in the cathode is from 13 wt % to 20 wt %.

5. The method of claim 4, wherein the cathode further comprises a binder of 7 wt % to 10 wt %, a conduction auxiliary of 3 wt % to 6 wt %, and an active material of 65 wt % to 75 wt %.

6. The method of claim 5, wherein the binder is polyvinylidene fluoride, the conduction auxiliary is conductive carbon black, and the active material is a lithium compound.

7. The method of claim 1, wherein the content of the second polymeric plasticizer in the anode is from 11 wt % to 27 wt %.

8. The method of claim 1, wherein the content of the second polymeric plasticizer in the anode is from 16 wt % to 22 wt %.

9. The method of claim 8, wherein the anode further comprises a binder of 7 wt % to 10 wt %, a conduction auxiliary of 2 wt % to 4 wt %, and an active material of 67 wt % to 71 wt %.

10. The method of claim 9, wherein the binder is polyvinylidene fluoride, the conduction auxiliary is conductive carbon black, and the active material is mesophase carbon micro bead.

11. The method of claim 1, wherein the content of the third polymeric plasticizer in the separator is from 40 wt % to 60 wt %.

12. The method of claim 1, wherein the content of the third polymeric plasticizer in the separator is from 45 wt % to 55 wt %.

13. The method of claim 12, wherein the separator further comprises a binder of 25 wt % to 33 wt %, and silicon dioxide of 15 wt % to 22 wt %.

14. The method of claim 13, wherein the binder is polyvinylidene fluoride.
